(19) United States
(12) Patent Application Publication
(10) Pub. No.: US 2002/0176913 A1
(43) Pub. Date: Nov. 28, 2002

(54) Device for making the head of a beverage or food

(76) Inventor: Denis Downey, Eire (IE)

Correspondence Address: ANTHONY R BARKUME, 20 GATEWAY LANE, MANORVILLE, NY, 11949, US

(21) Appl. No.: 10/155,610

(22) Filed: May 23, 2002

(30) Foreign Application Priority Data
May 25, 2001 (GB) 01 12866.9

(51) Int. Cl. A23L 1/00

(52) U.S. Cl. 426/87

(57) ABSTRACT

A device for marking the head of a beverage which has a body portion having a marking end which, in use, is held in or under a developing head whilst the beverage is poured and is then drawn through the head after the head has substantially developed. A method for marking the head of a pint of beer using this device, including the steps of pouring beer into a glass and forming a head thereon, and drawing said device through said head to form a mark therein. Preferably, at least part of the device is located under the head as it forms and then drawn through the head from underneath to the top of the head. In a second aspect, the device has a body portion with at least one opening defining a shape. A granulated substance is sprinkled through the opening and lands on the top of a beverage or a food in a pattern reflecting the shape of the opening.

### BACKGROUND OF THE INVENTION

This invention relates to a device for marking the head of a beverage or food, and more particularly, but not exclusively, to a device for marking the head of a beer and to a device for marking the head of a hot chocolate, cappuccino or a soup.

The presentation of a beverage in a public venue such as a coffee shop, bar, restaurant or public house is very important. The majority of the cost of a beverage in such venues is attributable to labour costs and the ambiance and upkeep of the venue. The beverage can generally be purchased from a retail outlet at a fraction of the price paid in such a venue. Hence, there is a need for a good and consistent presentation and appearance of the beverage. There is also a need for means to indicate if the beverage is of a poor quality, so that this can be rectified before the beverage reaches the customer.

Advertising and ways to get messages across to people is an exceedingly important tool for businesses. Advertisements for products and services appear, for example, on wall posters, on television, on cars and on drinking vessels. There is a need for additional new ways to advertise products and services.

A stout beer such as Guiness™, once poured has a dark, almost black body with an off-white, creamy head. One method of improving the appearance of a pint of stout beer, is to finish pouring the pint whilst moving the glass below the pouring nozzle tracking the outline shape of a shamrock. The liquid pouring from the nozzle cuts through the head of the Guiness™ leaving an outline of a shamrock therein. The thick consistency of the creamy head enables the outline of the shamrock to be visible for several minutes. However, this is a time consuming procedure and involves a certain amount of skill. Bar staff are under time pressure to pour a pint of stout.

### SUMMARY OF THE INVENTION

According to a first aspect of the present invention, there is provided a device for marking the head of a beverage, said device comprising a body portion having a marking end which in use, is held in or under a developing head whilst the beverage is poured and is then drawn through the head after the head has substantially developed.

The device of the first aspect of the invention may be used with most beverages which have a head capable of holding a shape, indentation or impression for a period of time.

The body may be of a shape suitable for forming a symbol such as a shamrock or may be lettering. The body may define an outline of a shape, which may be accomplished by having a body with an outer edge and an inner edge relatively close together, such that when the device is pulled through the head of the beer, a thin visible line is left in the head of the beer.

The device is preferably mountable on a part of a beer pouring apparatus, and most preferably on a nozzle of the pouring apparatus. The mouth and the lower part of the nozzle of the dispensing apparatus is usually held under the surface of the beer as it is being poured into a glass, at least during the final stage for example, as the final quarter of the pint is poured, therefore, the device may be arranged adjacent and preferably attached to the nozzle, such that the device can be immersed in the beer with the nozzle. The device will be drawn through the head of the beer as the glass is lowered from the nozzle.

Preferably, the device comprises a body and a ring attached to or integral therewith. The ring, in use, slides up a nozzle which converges towards a mouth of a pouring apparatus and is wedged thereon. Preferably, the ring is adapted to fit the nozzle at a point approximately 1 cm to 3 cm above the mouth of the nozzle.

The present invention also provides a nozzle comprising the device of the invention and a pouring apparatus comprising the device or the nozzle of the invention.

Preferably, the beverage is a beer. The device may be used to mark the heads of stout beers such as Guiness™ or smooth ales such as Caffreys™. The shape of the body may represent well known brand names, symbols, musical notes, emblems, letters, words, and numbers. The shapes may dictate the origin of goods and services and may be advertisements.

The first aspect of the present invention also provides a method for marking the head of a pint of beer using the device of the invention, the method comprising the step of pouring beer into a glass and forming a head thereon and the step of drawing said device through said head to form a mark therein. Preferably, at least part of the device is located under the head as it forms and then drawn through the head from underneath to the top of the head.

The first aspect of the invention also provides a glass of beer having a head, which head has a pattern thereon formed by drawing a device of the present invention through the head. Preferably, the pattern is formed by drawing the device from underneath the head to above the head.

We have found that if the mark does not form properly, or does not form clearly, there may be a problem with the beer and this provides a simple and early warning that the stout should not be served. There may alternatively or additionally be a problem with the way the beer has been poured.

One way of presenting a beverage such as a hot chocolate, cappuccino is to sprinkle chocolate granules or powder over the top of a milky foamy head. One way of presenting foods such as cakes is to sprinkle caster sugar over them.

A second aspect of the present invention provides a device for marking the tops of a beverage or a food, the device comprising a body portion having at least one opening defining a shape. In use, a granulated substance is sprinkled through the opening, the granulated substance landing on the top of a beverage or a food in a pattern reflecting the shape of the opening. For beverages, the body portion may be placable over a drinking vessel. For foods, the body portion may be placable a bowl or plate.

Preferably, the device further comprises a handle. Advantageously, the body portion is sized to cover the opening of a standard drinking vessel, such as a mug, cup, tumbler or pint glass. The device may further comprise a cushion layer, such that, in use, the device is less likely to damage a drinking vessel if placed on the top thereof or dropped heavily thereon. Alternatively, the body portion is sized to cover a bowl or a substantial portion of a plate.

The opening may define a shape used to dictate the origin or for advertising other products and services. The shape may be a symbol dictating origin of the beverage. The shape may be a word or numeral, preferably used in advertising a product or service.

The invention also provides a beverage comprising an image produced using the device as claimed in any preceding claim.

For a better understanding of the present invention, reference will now be made, by way of example, to the accompanying drawings, in which:

### BRIEF DESCRIPTION OF THE DRAWING

FIG. 1 is a perspective view of a device in accordance with a first aspect of the invention, in use;

FIGS. 2 and 3 are respectively, a top plan view and front elevation of the device of FIG. 1;

FIGS. 4a, 4b and 4c are respectively, a top plan view, a side elevation and an underneath view of a first embodiment of a device in accordance with a second aspect of the invention, for facilitating marking the tops of beverages;

FIG. 4d is a perspective view of the device of FIGS. 4a to 4c, in use;

FIGS. 5a and 5b are respectively, a top plan view and a side elevation of a second embodiment of a device in accordance with a second aspect of the invention, for facilitating marking the tops of beverages;

FIGS. 6, 7, 8 and 9 are top plan views of four further embodiments of devices in accordance with the second aspect of the invention; and

FIG. 10 is a perspective view of a further device in accordance with the second aspect of the invention.

### DESCRIPTION OF THE PREFERRED EMBODIMENT

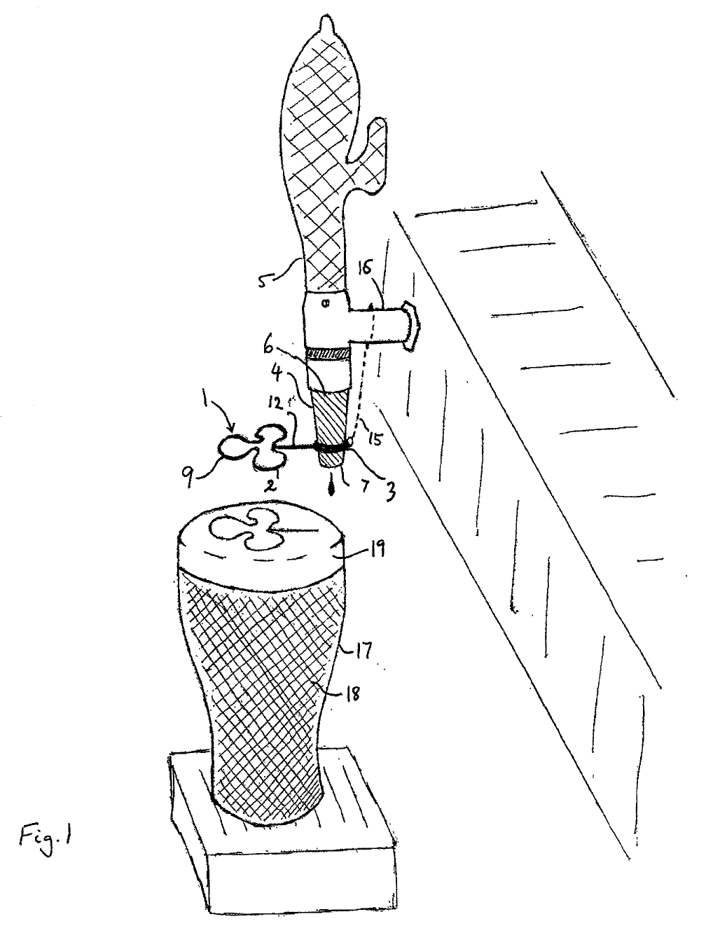

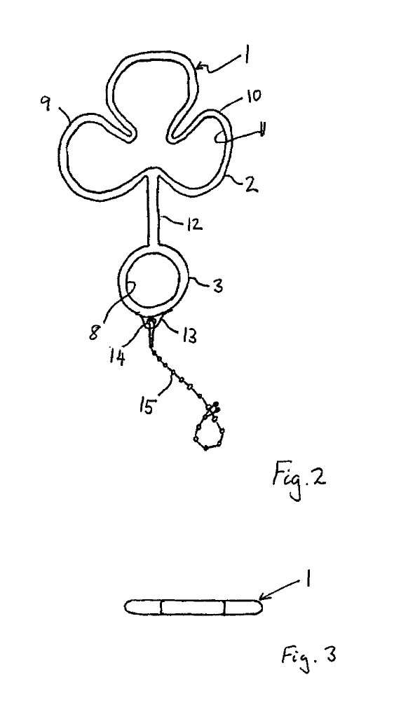

Referring to FIGS. 1 to 3, there is shown a device, which is generally identified by reference numeral 1. The device 1 comprises a body portion 2 moulded from a rigid plastics material. The device 1 has an attachment end having a ring 3 adapted to be slid over the end of a nozzle 4 of a pump 5 for dispensing beer. As shown in FIG. 1, the nozzle 4 is generally conical and tapers from an upper end 6 to a mouth 7. The ring 3 has an internal diameter greater than the diameter of the mouth 7, but the same or smaller than the diameter of the upper end 6 of the nozzle 4. The ring 3 has sufficient rigidity and has an inner surface 8 having sufficient skin friction, such that upon sliding the ring 3 upwardly along the nozzle 4, the inner surface 8 of the ring 3 engages the nozzle 4 at a point intermediate the mouth 7 and the upper end 6 of the nozzle 4, and stays attached thereto by a friction fit and/or grips the nozzle 4. The ring 3 is preferably sized to fit on to the nozzle 4 at a point approximately 1 cm above the mouth 7.

The body portion 2 has a marking end 9 which has an outer edge 10 defining the shape of a three leaf shamrock and an inner edge 11 substantially parallel thereto. The distance between the internal and external edges is approximately 1.5 mm (1/16^{th}inch). The marking end 9 is formed integrally with one end of a stalk 12, the other end of which is formed integrally with and is in the same plane as the ring 3. The width of the stalk 12 is approximately 1.5 mm (1/16^{th}inch). The depth of the marking end 9 and the stalk 12 is approximately 1.5 mm The thickness of the ring 3 is approximately 1.5 mm. The distance between the far end of the ring 3 and the far end of the marking end 9 is less then the diameter of the opening of a pint glass, and may be less than the diameter of the opening of a half pint glass.

A lug 13 is formed integrally with the body portion 2 on the ring 3. The lug 13 is provided with a hole 14 for attachment to a chain 15. The chain 15 may be attached to a neck 16 of the pump 5.

The ring 3, the marking end 9, the stalk 12 and the lug 13 are all formed integrally in a one-piece structure. Preferably, the one-piece structure is injection moulded in an ABS plastic, polyacetal or a polycarbonate material.

In use, a barman attaches the chain 15 to the neck 16 of the pump 5. He then slides the ring 3 of the marking device 1 over the mouth 7 of the tapering nozzle 4 until it firmly engages the nozzle 4. The marking end 9 of the marking device 1 extends substantially horizontally from the nozzle 4. The barman then pours a pint in a usual manner. In the case of a stout beer such as Guiness™, three-quarters of a pint should be poured into a pint glass 17 through the mouth 7 of the nozzle 4 of the pump 5 whilst holding the pint glass at approximately 45° to the horizontal. The pint glass 17 containing three-quarters of a pint of Guiness™ is then left to stand for about two minutes. The pint glass 17 is then offered up to the pump 5 and raised until the mouth 7 of the nozzle 4 and the device 1 is submerged immediately below the level of the Guiness™. The pint glass 17 is inclined at a slight angle. A further quarter of a pint is then poured into the pint glass 17, rotating the glass to the vertical whilst a creamy thick head 19 forms. The body portion 2 of the device 1 is now also submerged, below the forming head 19. Once a full pint has been poured, the pint glass 17 is vertical. The barman stops the pump 5 and lowers the pint glass 17 away from the nozzle 4. In so doing, the marking device 1 passes upwardly through he head of the beer. The marking end 9 leaves an impression of a shamrock in the top of the creamy thick head 19 of the beer 18. This also may improve quality control. In particular, if the impression isn't visible on a finished pint, the bartender will notice this and inform his manager or cellar man of this problem. This gives the manager or cellar man notice before the customer receives his pint, so that he can correct this problem, which may be caused by a problem with the pouring apparatus, or the storage conditions of the beer.

The marking device 1 is removable from the nozzle 4 to facilitate cleaning and maintenance.

The body portion 2 may define any suitable shape, such as a heart, letters, words or other symbols and pictures.

It is envisaged that the device 1 may be provided with another means of attachment to the nozzle 4 or the pump 5. In particular, a nozzle 4 may have a threaded pin at its upper end for attachment to a internally threaded bore in a pump. The device 1 may have a vertical arm extending from the stalk 12, which is provided at the upper end thereof with a circular flange having a hole therethrough for receiving the threaded pin of the nozzle.

It is further envisaged that the device 1 may be formed integrally with the nozzle 4. It is further envisaged that the body 2 may be made from a wire, bent into a shape to be reflected in the head of a beer.

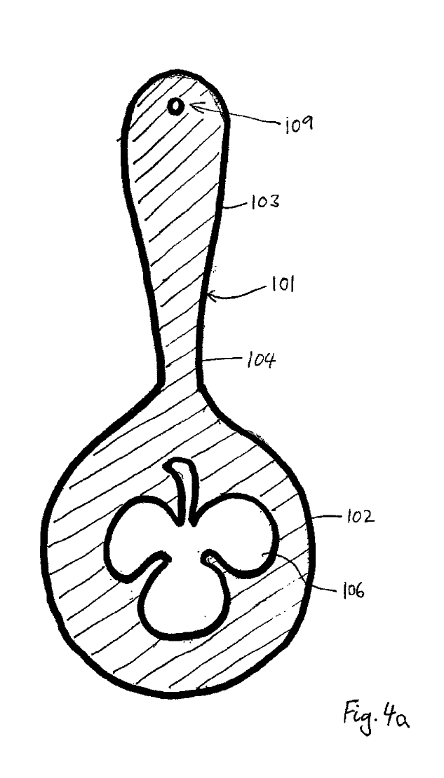

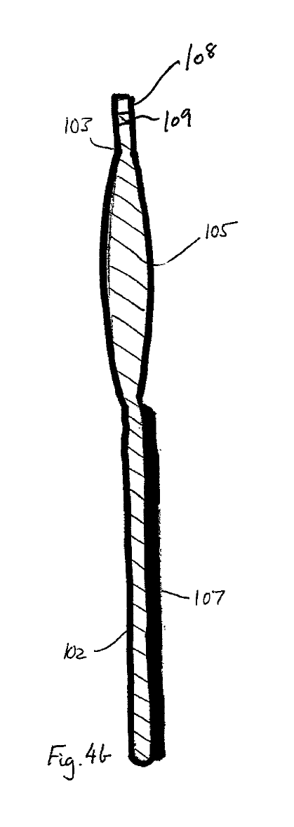

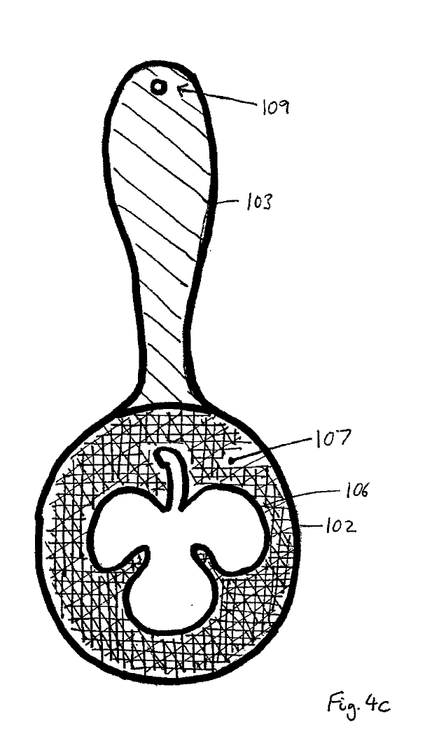

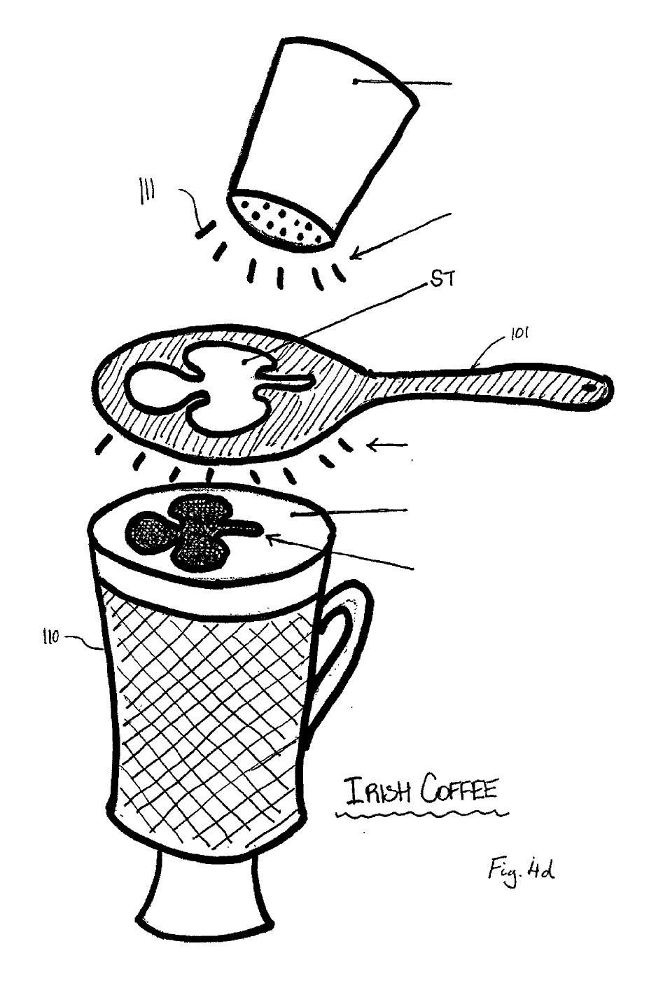

Referring now to FIGS. 4a to 4d there is shown a device for facilitating marking the tops of beverages or foods which is generally identified by reference numeral 101. The device 101 has a head 102 and an integral handle 103. The head 102 is generally disk shaped having a diameter of approximately 10?cm. The head 102 has a thin neck 104 leading to the handle 103, which has a bulbous grip 105. The head 102 has an opening 106 in the shape of a shamrock. The underside of the head 102 has a rubber disk 107 adhered thereto, which has a similarly shaped opening, in registration with the opening 106. The handle 103 has a flattened end portion 108 with a hole 109 therethrough for receiving a string loop or a hook for facilitating storage of the device.

In use, the device 101 is placed on top of or held above a mug 110 by a user, as shown in FIG. 4d. The mug 110 may be a cup, glass or other drinking vessel. The user sprinkles a granulated substance 111 such as, icing sugar or chocolate powder over the top surface of the head 102 of the device 101. The granulated substance falls through the opening 106 on to the surface of the liquid in the mug 110. Surface tension in the surface of the liquid, the shape and the density of the granulated substance inhibits the granulated substance from immediately sinking to the bottom of the mug 110. The device 101 is moved away from the top of the mug 110 leaving an image or shape on the surface of the liquid in the mug. The shape or image is enhanced by using a granulated substance having a contrasting colour to that of the top of the liquid or on a head thereof. The device may be used in a similar way over foodstuffs.

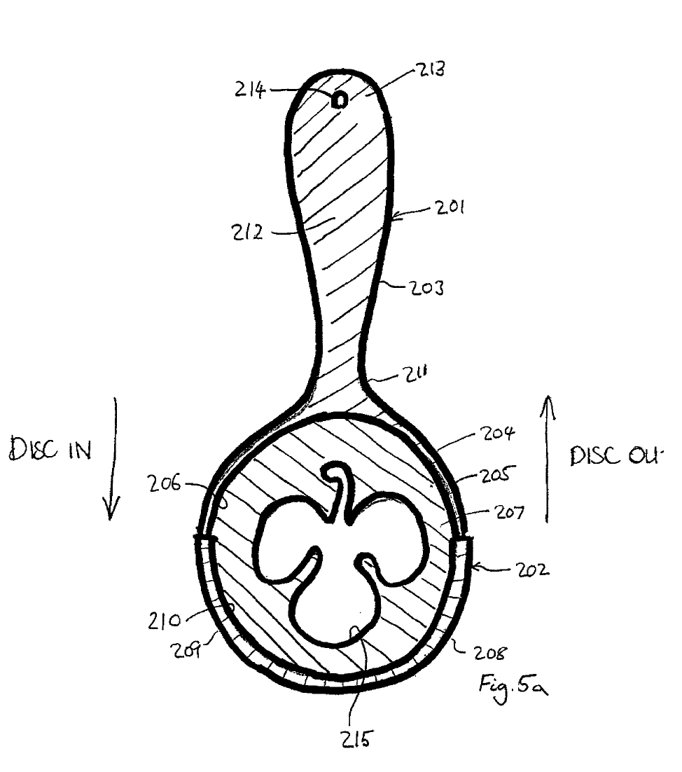

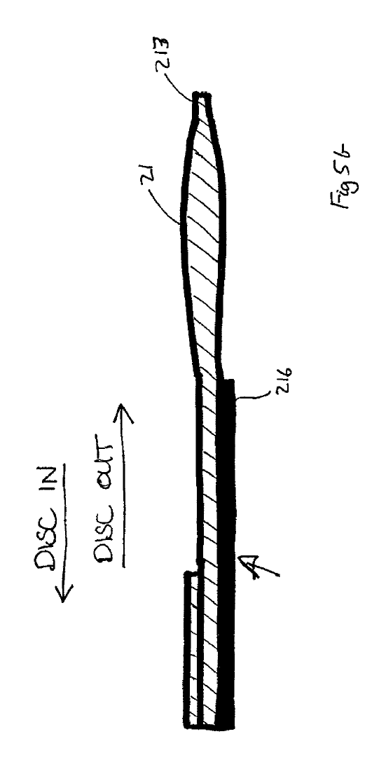

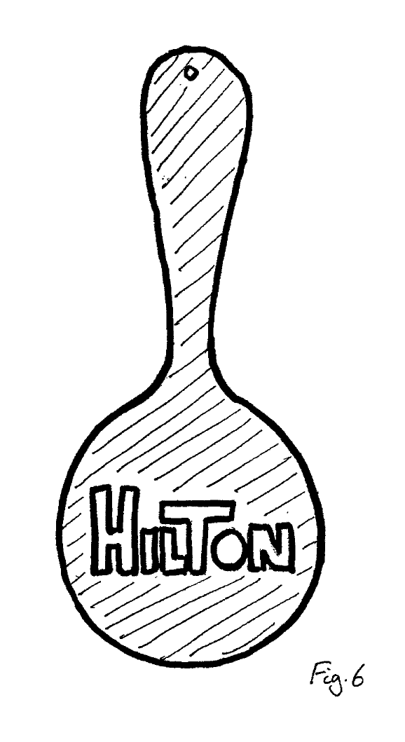

Referring now to FIGS. 5a and 5b there is shown a device for facilitating marking the tops of beverages or foods. The device, which is generally similar to that of FIGS. 4a to 4d, is generally identified by reference numeral 201. The device 201 has a head 202 and an integral handle 203. The head 202 comprises a rim 204 having outer 205 and inner edges 206, which are generally circular, having a diameter of approximately 10 cm?. The inner edge 206 is provided with a shoulder (not shown) for receiving a disc 207. A cap 208 is provided to lock the disk 207 to the rim 204. The cap 208 has an outer 209 and an inner edge 210. The inner edge 210 is provided with a shoulder (not shown) which engages the inner edge 206 of the rim 204 to retain the disk 207. The first portion 204 has a thin neck 211 leading to the handle 203, which has a bulbous grip 212 and a flattened end portion 213 with a hole 214 therethrough for receiving a string loop or a hook for facilitating storage of the device 201.

The disk 207 has an opening 215 in the shape of a shamrock. The underside of the disk 207 has a rubber disk 216 adhered thereto, which has a similarly shaped opening, in registration with the opening 215.

In use, the disk 201 is seated on the shoulder in the rim 204 of the device 201. The cap 208 is offered up to the disk 207, such that the shoulder of the cap 208 slots over and engages with the inner edge 206 of the rim 204. The device 201 is placed on top of or held above a mug in the same way as described with reference to FIG. 4d.

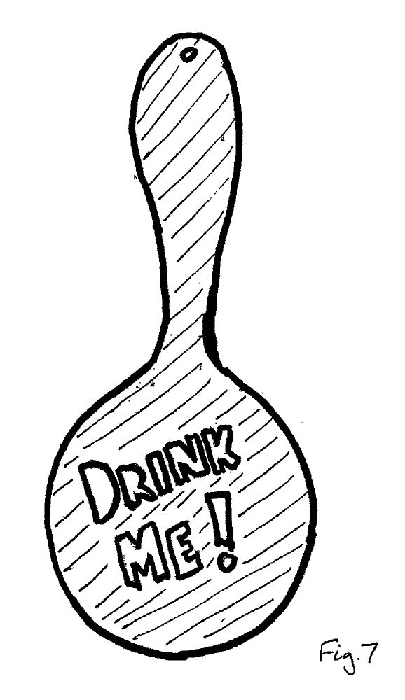

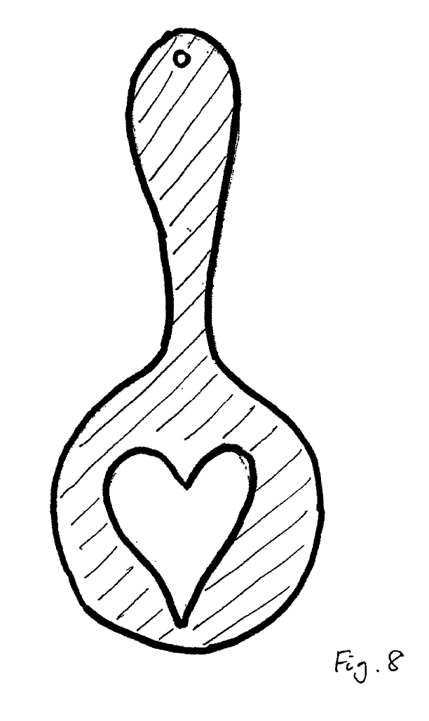

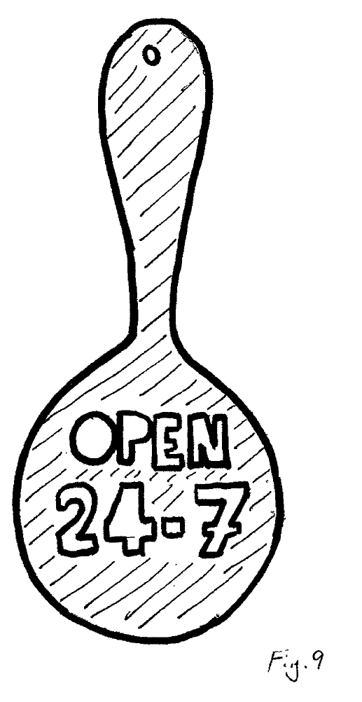

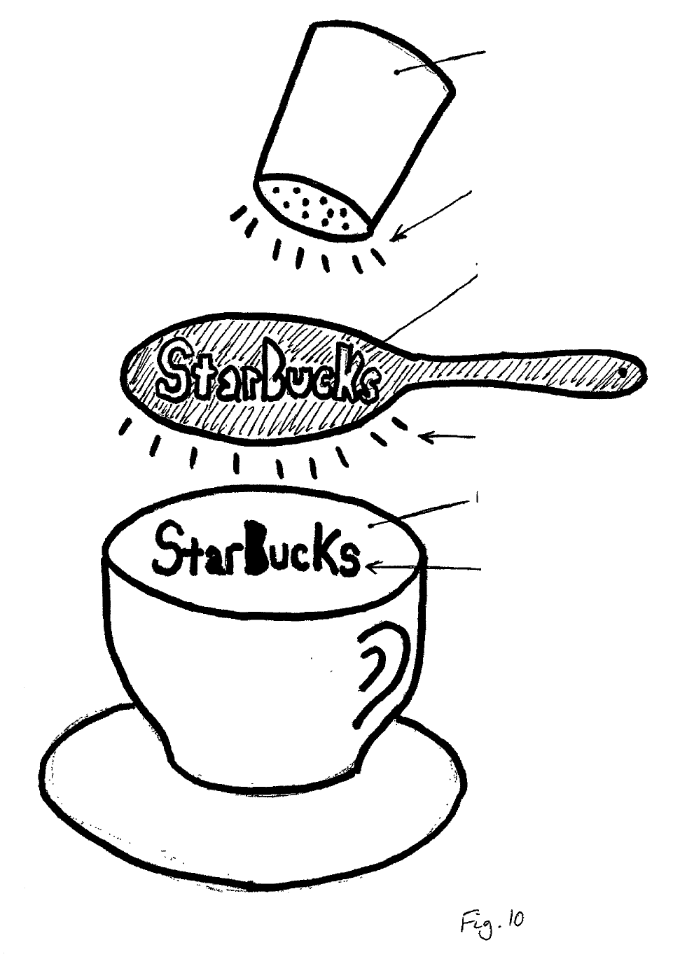

FIGS. 6 to 9 show devices which have various different shaped openings which could be applied to the device of FIGS. 4a to 4d or be used in the disk of FIGS. 5a and 5b.

Various modifications to the above described embodiments are envisaged. In particular, instead of a single opening in the disk defining a shape, the disk could comprise a plurality of small holes set out in a shape which will produce a recognisable image on top of a beverage or head of a beverage when a granulated or powdered substance is shaken therethrough. The image is preferably associated with advertising a product or service.

What is claimed is:

1. A device for marking the head of a beverage, said device comprising a body portion having a marking end which in use, is held in or under a developing head whilst the beverage is poured and is then drawn through the head after the head has substantially developed.

2. A device as claimed in claim 1, wherein the beverage is a beer such as a stout or a smooth ale.

3. A device as claimed in claim 1, wherein said marking end defines an outline of a shape.

4. A device as claimed in claim 1, wherein said marking end with an outer edge and an inner edge relatively close together, such that when the device is pulled through the head of the beverage, a thin line is left in the head of the beverage.

5. A device as claimed in claim 1, wherein said device is mountable on a part of a beverage pouring apparatus.

6. A device as claimed in claim 5, wherein said device is mountable on a nozzle of the pouring apparatus.

7. A device as claimed in claim 6, wherein said device comprises a ring attached to or integral with said body portion, the ring, in use, is slid up a nozzle which converges towards a mouth thereof and is wedged thereon.

8. A device as claimed in claim 7, wherein said ring is adapted to fit the nozzle at a point between 1 cm and 3 cm above the mouth of the nozzle.

9. A device as claimed in claim 1, wherein the marking end is in the shape of at least one of the following: a well known brand name; a symbol; a musical note; an emblem; a letter; a word; and a number.

10. A device as claimed in claim 1, wherein said marking end is in the form of a trademark.

11. A nozzle comprising a device as claimed in claim 1.

12. A pouring apparatus comprising the device as claimed in claim 1.

13. A pouring apparatus as claimed in claim 12, connected to a stout beer.

14. A method for marking the head of a pint of beer using a device as claimed in claim 1, the method comprising the step of pouring beer into a glass and forming a head thereon and the step of drawing said device through said head to form a mark therein.

15. A beverage having a head, which head has a pattern thereon formed by drawing a device as claimed in claim 1 through the head.

16. A device for marking the top of a beverage or a food, the device comprising a body portion having at least one opening defining a shape.

17. A device as claimed in claim 16, further comprising a handle.

18. A device as claimed in claim 16, wherein said body portion is sized to cover the opening of a drinking vessel, such as a mug, cup, tumbler or pint glass.

19. A device as claimed in claim 16 further comprising a cushion layer, such that, in use, the device is less likely to damage a drinking vessel if placed on the top thereof or dropped thereon.

20. A device as claimed in claim 16, wherein said opening has a shape which indicates the origin of products and services.

21. A device as claimed in claim 16, wherein the opening defines a shape which is a trademark.

22. A beverage or a food provided with an image produced using a device as claimed in claim 16.
